(19) United States
(12) Patent Application Publication
(10) Pub. No.: US 2014/0016976 A1
(43) Pub. Date: Jan. 16, 2014

(54) Digital Printing Apparatus and Method with Improved Toner Removal

(71) Applicant: Xeikon IP BV, Eede (NL)

(72) Inventors: Nick Horemans, Noorderwijk (BE); Maarten Achten, Zonhoven (BE); William Constant Maria Waterschoot, Belsele (BE)

(21) Appl. No.: 13/938,142

(22) Filed: Jul. 9, 2013

(30) Foreign Application Priority Data
Jul. 10, 2012 (EP) 12175762.9
Apr. 5, 2013 (EP) 13162577.4

(51) Int. Cl. G03G 21/00

(52) U.S. Cl. CPC G03G 21/0088
USPC 399/348

(57) ABSTRACT

A digital printing method using liquid toner, the method comprising transporting liquid toner comprising charged, caked and compacted imaging particles on a first member (101) in a transport direction of said first member; wherein the method further comprises loosening compacted and caked imaging particles by rubbing using a rubbing portion that is being pressed against the first member and that at least partially contains or absorbs the liquid toner while being pressed against the first member; and scraping off loosened and decaked imaging particles using a scraper downstream of an area of contact between the first member and the rubbing portion.

### RELATED APPLICATIONS

The present application claims priority to European patent application no. 12 175 762.9 filed Jul. 10, 2012, and European patent application no. 13 162 577.4 filed Apr. 5, 2013, the disclosures of each of which are incorporated herein by reference for all purposes.

### BACKGROUND

The present disclosure pertains to the field of digital printing apparatus and methods, in particular systems and methods using liquid toner, and more in particular to a digital printing method and apparatus according to the preamble of claims 1 and 7, respectively.

Digital printing apparatus using liquid toner is known from US patent application publication no. 2011/0249990. The known digital printing apparatus comprises a feed roller, a developer roller, developer roller cleaning means, and an image carrying roller; the feed roller being arranged to transfer a quantity of liquid toner from a reservoir onto the developer roller; and the developer roller being arranged to transfer a portion of the quantity of liquid toner onto the image carrying roller in accordance with a charge pattern sustained on a surface of said image carrying roller.

In digital printing systems of this kind, it is necessary to remove the liquid toner residue that remains on the surface of the developer roller after contact with the imaging roller. Also the liquid toner residue that remains on the surface of the imaging roller after contact with a transfer roller after contact with a substrate needs to be removed. More generally, it may be desirable to remove a residue remaining on any roller of the apparatus. It is observed that these highly concentrated and therefore highly viscous compacted toners are not easily decompacted and removed from rollers. Thus, the removal of such a residue can be quite challenging.

Unpublished European patent application no. 12 175 762.9 in the name of the Applicant describes the use of an oscillating electric field arranged to substantially decompactify the chargeable imaging particles in a liquid toner residue on a developer roller, prior to or during its mechanical removal.

### SUMMARY

It is a purpose of embodiments of the present disclosure to provide a digital printing system and method allowing for improved residual toner removal. More in particular, the purpose of embodiments of the disclosure is to provide a loosening means that can be used as an alternative for the solution proposed in the above mentioned European patent application no. 12 175 762.9, or in combination with the solution proposed in the above mentioned European patent application no. 12 175 762.9.

This goal is achieved by a method for digital printing and a digital printing apparatus which are distinguished by the features of the characterizing portion of claims 1 and 7, respectively. An embodiment of a digital printing method using liquid toner comprises transporting liquid toner comprising charged, caked and compacted imaging particles on a first member in a transport direction of said first member. If the first member is a developer member, typically first a quantity of liquid toner comprising uncharged imaging particles is fed on the first member, whereupon the chargeable imaging particles are charged, compacted and caked by applying an electric field in order to obtain liquid toner comprising charged, caked and compacted imaging particles, which is transferred in part to an imaging roller, such that a remaining fraction remains present on the developing roller. If the first member is an imaging roller or further intermediate roller, already charged, compacted and caked imaging particles are fed on the imaging roller or further intermediate roller, and a part thereof is transferred to a further member or substrate, also leaving a remaining fraction on the imaging roller or further intermediate roller. The method further comprises loosening the remaining fraction of compacted and caked imaging particles by rubbing using a rubbing portion that is being pressed against the first member and that at least partially contains or absorbs the liquid toner while being pressed against the first member; and scraping off loosened imaging particles using a scraper downstream of an area of contact between the first member and the rubbing portion.

An embodiment of the digital printing apparatus comprises a first member arranged to receive and transport a quantity of liquid toner, as well as a loosening member arranged to loosen liquid toner present on the first member. The loosening member has a rubbing portion arranged to act on the liquid toner to be removed from the first member. The rubbing portion is arranged and configured for being reversibly compressed by the first member and for being capable of at least partially containing or absorbing the liquid toner during compression by the first member. Further, there is provided a scraper, which is arranged opposite to the first member, downstream of an area of contact between the first member and the loosening member.

Embodiments of the present disclosure are based inter alia on the inventive insight that two distinct but related effects have to be overcome to efficiently remove the liquid toner from the developer roller: the tendency of the imaging particles to stay close to the surface of the roller (this “compacting” of the toner is in fact deliberately induced to a certain degree at the charging stage), and the tendency of the imaging particles to cling together in large quantities to form gelatinous structures (known as “caking”). This caking could be described as toner particles coming so close to each other that they start to feel each others presence and start to align themselves under the influence of the high electric field. This is thought to be due to the long hydrophobic carrier liquid loving tails of the dispersing agents present on the surface of the toner particles interacting with each other. The inventors also observed that this caking is influenced by the shape of the toner particles. Flat Frisbee disc shaped particles are much more vulnerable to this caking behavior compared to more rounded rugby ball shaped toner particles or to perfectly rounded toner particles.

Embodiments of the present disclosure are based inter alia on the surprising discovery by the inventors, that by having liquid toner rubbed by a rubbing portion whilst being absorbed or contained in or on the rubbing portion, the tendency of the imaging particles to stick together and/or to stick to the surface is removed. This discovery is surprising because it could not be expected that simple mechanical rubbing means would influence the small-scale mechanical and physico-chemical effects that tend to keep the liquid toner in a caked form. However, it turns out that absorbing or containing the liquid toner in or on the rubbing portion, and deforming the rubbing portion, positively influences these effects. Those effects could not be established by scraping of the compacted layer of the development roller, even when electrical decompaction has been performed.

According to a preferred embodiment of the method of the disclosure, the first member is a developer member, and the method further comprises producing a latent image as a pattern of electric charge on an imaging member; and developing said latent image by transferring a portion of the liquid toner comprising charged, caked and compacted imaging particles onto said imaging member, in accordance with said pattern. The developing leaves a remaining fraction of said liquid toner on the developer member and the loosening with the rubbing portion is performed on said remaining fraction on said developer member. Preferably, the rubbing portion is biased with a bias voltage or current capable of discharging the charged, compacted and caked imaging particles. This discharging will further improve the cleaning and decaking performance of embodiments of the disclosure.

In preferred embodiments, the first member is any one of the following: a development member arranged to receive a quantity of liquid toner, and to develop a latent image by transferring a portion of the quantity of liquid toner onto an imaging member; an imaging member adapted to sustain a pattern of electric charge forming a latent image on its surface; or a transfer member configured for transferring liquid toner from an imaging roller to a substrate.

According to a preferred embodiment, the rubbing portion is made of an elastic foam material capable of absorbing liquid toner, preferably without being sensitive to swelling by the carrier liquid. A cellular foam material has the advantage that liquid toner can be easily absorbed in the cells of the foam material. This results in a rubbing action being performed on the liquid toner when the rubbing portion is compressed. Preferably, the rubbing portion is made of a porous elastic material having a density which is smaller than 150 kg/m³, preferably smaller than 120 kg/m³, and e.g. between 30 and 50 kg/m³. Such materials provide a good absorption of the liquid toner. The inventors believe that it is likely that the movement of the foam cells creates a potential micro turbulence rewetting the toner particles with dispersing agent.

According to another embodiment, the rubbing portion may have an uneven surface. More in particular, the rubbing portion may be provided at the surface with holes, cavities, or channels configured for containing liquid toner during compression. In that way, also non-foam materials may be used to obtain similar effects. The surface of the rubbing portion could e.g. be provided with slits or channels or perforations in which liquid toner present on the first member can enter upon contact with the rubbing portion.

According to yet another embodiment, the loosening member may be a brush roller with bristles to mechanically break up toner particle aggregates that may be formed as a result of physical and electrophoretic compaction. The bristles are adapted to contain the liquid toner while being pressed against the first roller, and to perform a rubbing action on the liquid toner.

In a typical embodiment, the digital printing apparatus comprises an actuator for moving the loosening member such that liquid toner absorbed or contained in or on the rubbing portion is rubbed during the movement of the loosening member. This movement could e.g. be a rotational movement around a rotation axis parallel to a rotation axis of the first member, and/or an axial movement parallel to the surface of the first member and/or a movement perpendicular to the surface of the first member. According to a preferred embodiment, the loosening member is a rotatable member being in operation in rotating contact with the first member. The actuator may then be configured for rotating the loosening member.

According to a preferred embodiment, seen at an area of contact between the first member and the loosening member, the loosening member rotates in an opposite direction, compared to the first member. In that way, a liquid pickup zone is created upstream of the area of contact between the first member and the loosening member, and a squeeze-out zone is created downstream of said area of contact. Such an embodiment has the advantage that the loosening member also fulfills the function of picking up liquid toner from the first roller, as well as of removing the picked up liquid toner from the loosening member. In preferred embodiments, the contact between the first member and the loosening member is such that a nip is created between the first member and loosening member. When a quantity of liquid present on the first member arrives at the nip, it will be taken up in the nip, and rubbed and agitated in the nip as a consequence of the counter rotating loosening member. The loosened liquid toner is picked up at one end of the nip by the counter rotating loosening member, and, after a full rotation of the loosening member, is reintroduced in the nip, at the other end thereof, and squeezed out of the rubbing portion.

Preferably, the loosening member is a roller, and the rubbing portion is provided as a cylindrical outer layer of the roller. The thickness of this cylindrical outer layer is preferably more than 3 mm.

Although certain embodiments above comprise a counter-rotating loosening member, according to other variants of the disclosure, the loosening member may rotate in the same direction as the first member. Further, in both cases, the first member may have a first rotational speed which is different from a rotational speed from the loosening member. Typically, the speed of the loosening member will be chosen so that a good compromise is obtained between performance and wear behavior. Preferably, the absolute value of the speed of the loosening member is larger than 0.20 times the absolute value of the speed of the first member, e.g. between 0.20 and 0.50 times the speed of the first member.

According to preferred embodiments, the rubbing portion is made of any one of the following materials: polyurethane foam, silicone foam, viscose, rubber, Teflon. Typically, the material of the rubbing portion is determined in function of the strength and hardness of the first member, typically a development roller, and in function of the chemical and swelling resistance towards the carrier liquid used in the printing process.

Further, in typical embodiments, there is provided a second member in contact with the first member, wherein the first member is configured and arranged to transfer a portion of the quantity of liquid toner onto the second member, leaving a remaining fraction of this quantity of liquid toner on the first member. The loosening member is then arranged to act on the remaining fraction. The second member may e.g. be an imaging member adapted to sustain a pattern of electric charge forming a latent image on its surface, in which case the first member is a development member arranged to receive a quantity of liquid toner, and to develop the latent image by transferring a portion of said quantity of liquid toner onto the imaging member in accordance with a pattern. In such an embodiment a charging member may be arranged opposite to the first member, upstream of an area of contact between the first member and the second member.

Also, according to another aspect of the disclosure there is provided a loosening member for use in a digital printing apparatus. Further the disclosure relates to a use of a loosening member in combination with a scraper for reducing caking of imaging particles in liquid toner. Embodiments of the loosening member may have any one of the features disclosed above in connection with embodiments of the digital printing apparatus.

The accompanying drawings are used to illustrate presently preferred non-limiting exemplary embodiments of digital printing apparatus of the present disclosure. The above and other advantages of the features and objects of the disclosure will become more apparent and the disclosure will be better understood from the following detailed description when read in conjunction with the accompanying drawings, in which:

### BRIEF DESCRIPTION OF THE DRAWINGS

FIG. 1 is a schematic view illustrating a first embodiment of the disclosure;

FIG. 2 is a schematic view illustrating a second embodiment of the disclosure;

FIG. 3 is a schematic view illustrating a third embodiment of the disclosure;

FIG. 4 is a schematic view illustrating a fourth embodiment of the disclosure;

FIG. 5 is a schematic view illustrating a fifth embodiment of the disclosure;

FIG. 6 is a schematic view illustrating a sixth embodiment of the disclosure;

FIG. 7 is a schematic view illustrating a digital printing apparatus according to an embodiment of the disclosure, including a plurality of loosening rollers; and

FIG. 8 is a graph showing the optical density measured after a cleaning scraper for different test configurations, in order to illustrate the improved cleaning performance of embodiments of the disclosure.

### DETAILED DESCRIPTION

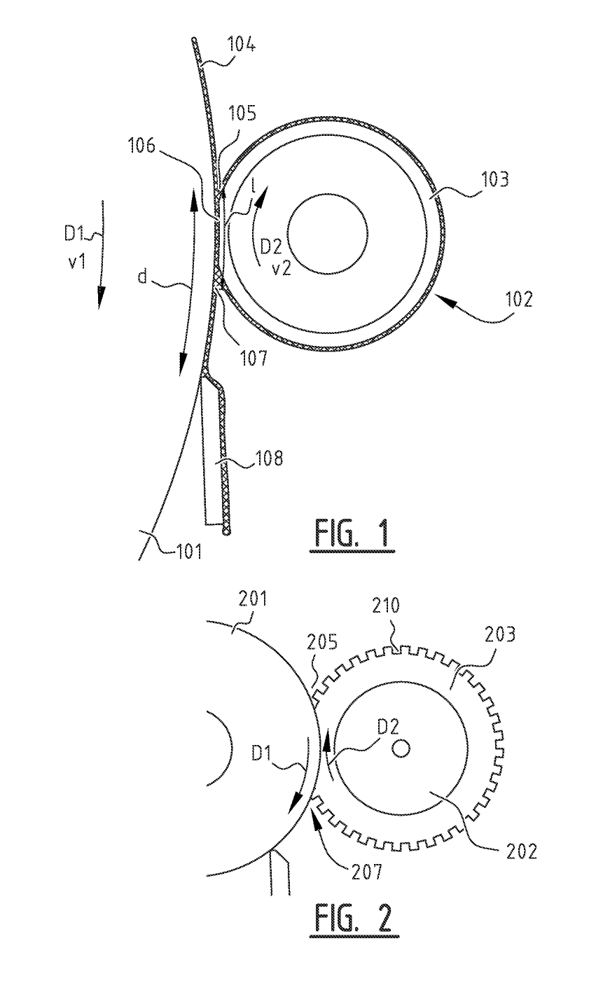

FIG. 1 illustrates a first embodiment comprising a first roller 101, e.g. a developer roller, configured for rotating in a first rotation direction D1, in combination with a counter rotating loosening roller 102 configured for rotating in an opposite rotation direction D2. The loosening roller 102 is provided with a rubbing portion in the form of a porous outer layer 103, typically made of a foam material, e.g. a polyurethane foam or a silicone foam. It is assumed that a thin liquid layer 104 containing charged, compacted and caked particles, is transported on the first roller 101. The loosening roller 102 is in rotational contact with the first roller 101, such that a nip 106 is formed between the first roller 101 and the loosening roller 102. The length (l) of the nip is preferably larger than 1 mm, more preferably larger than 4 mm, and most preferably larger than 5 mm. The pressure, calculated as the force divided by the width in axial direction, between the first roller 101 and the loosening roller 102 is e.g. between 10 and 200 N/m. In that way, the material of the porous rubbing outer layer 103 is compressed in the nip. The thin liquid layer enters the nip 106 in an entrance zone 105, where it is absorbed by the rubbing layer 103 and agitated. As the liquid is loosened up by the loosening roller 102, it is picked up from the picking-up zone 105, and brought back into the nip after a full rotation of the loosening roller 102. When re-entering the nip in zone 107, the liquid is squeezed out of the porous outer layer 103 and flows along the first roller 101. Optionally, in addition there may be provided an additional squeegee (not shown) running in contact with the loosening roller 102 to squeeze the liquid out of the loosening roller 102. A scraper 108 downstream of the loosening roller 102 removes the loosened imaging particles from the first roller 101. The scraper 108 is operative at a location on the first roller 101 at a distance d of the first contact between the loosening roller 102 and the first roller 101, seen in the transport direction D1. The distance d is preferably at least 5 mm.

In this embodiment, the loosening roller 102 has two functions:
a transport function consisting of picking up toner in a zone 105, during opening of foam cells of the outer layer 103, while coming out of the nip 106; and of squeezing out liquid toner during nip re-entrance in zone 107;
a rubbing and agitating function consisting of moving the toner particles in the nip as a consequence of the counter rotating rollers 101 and 102.

The loosening roller 102 may rotate at the same rotational speed as the first roller 101, or at a different rotational speed. Those speeds may be further optimized for an optimal loosening performance and a minimum wear. Preferably, the absolute value of the speed v2 of the loosening member is larger than 0.20 times the absolute value of the speed v1 of the first member, e.g. 0.20*v1<v2<0.70*v1.

FIG. 2 illustrates a second embodiment comprising a first roller 201 rotating in a first direction D1, and a loosening roller 202 rotating in an opposite direction D2. First roller 201 and loosening roller 202 are in rotational contact, and the operation is similar to the operation described above in connection with the embodiment of FIG. 1. However, in the embodiment of FIG. 2 the outer layer of the loosening roller 202 takes the form of a rubber outer layer having a surface which is provided with channels 210 for containing toner liquid. In this embodiment, the channels 210 will be open in the liquid pick-up zone 205 for picking up liquid. The picked-up liquid will re-enter the nip in a zone 207, whereupon it will be squeezed out of the channels 210. In yet another non-illustrated embodiment the loosening roller 202 may be a brush roller with bristles.

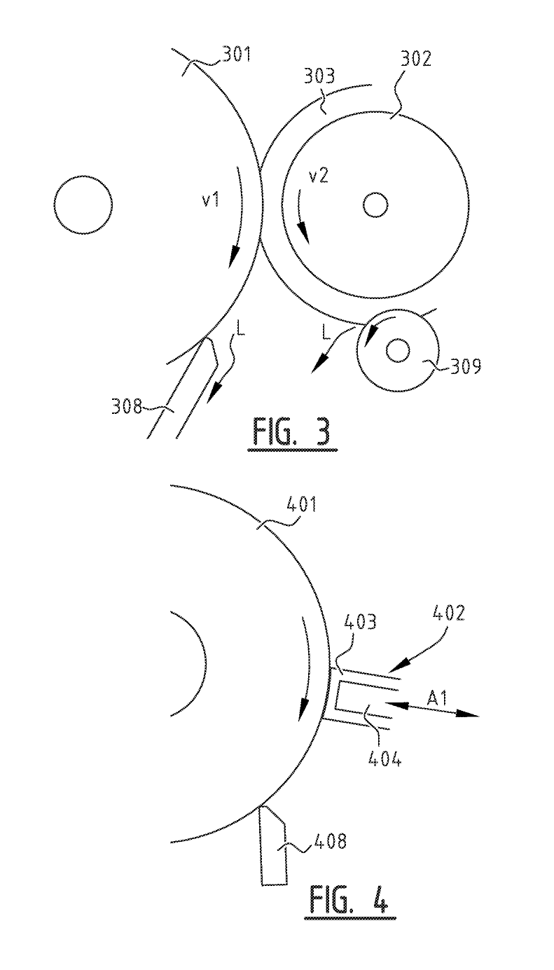

FIG. 3 illustrates a third embodiment, comprising a first roller 301 and a loosening roller 302. In this embodiment the first roller 301 rotates in the same direction as the loosening roller 302. According to a preferred embodiment, the loosening roller 302 rotates at a different rotational speed v2 compared to the rotational speed v1 of the first roller 301. The speed v2 of the loosening roller may be higher or lower than the speed v1 of the first roller. This will allow the loosening roller 302 to pick up enough liquid toner. Those speeds may be further optimized for an optimal loosening performance and limited wear. In such an embodiment there may be provided a further squeegee roller 309 opposite to the loosening roller 302 in order to remove the toner liquid absorbed or contained in the outer layer 303 of the loosening roller 302. Further, there is provided a scraper 308 which is similar to the scraper described in connection with FIG. 1.

FIG. 4 illustrates a fourth embodiment of the present disclosure, comprising a first roller 401 and a loosening blade 402. The loosening blade 402 comprises a rigid part 404 which is at least partially covered by a rubbing portion 403. The rubbing portion 403 may e.g. be made of a flexible foam material or any other porous material capable of absorbing or containing liquid toner. The loosening blade 402 is preferably mounted against a surface of the first roller 401, such that the rubbing portion 403 is compressed. In order to obtain a squeeze out effect, the loosening blade 402 could be moved back and forward in a direction perpendicular to the surface of the first roller 401 as indicated by arrow A1. Further, a scraper 408 is provided downstream of the loosening blade 402 in order to remove the loosened liquid layer from the first roller 401.

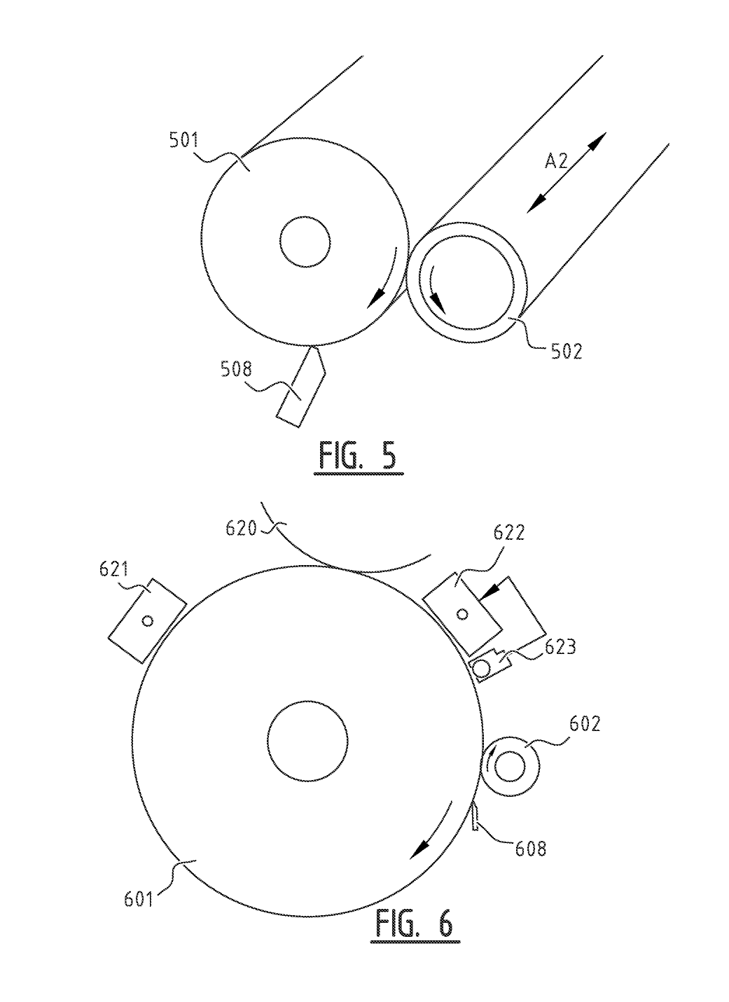

FIG. 5 illustrates yet another embodiment which is similar to the embodiment of FIG. 3, but is different in that the loosening roller 502 is also moved axially with respect to the first roller 501, as indicated by arrow A2. To that end there may be provided an actuator for moving the loosening roller 502 back and forward with respect the first roller 501. Note that the same actuator may produce both the axial movement and the rotation of the loosening member 502. Further, as in the previous embodiments, there is provided a scraper 508 downstream of the loosening roller 502 for scraping off the loosened imaging particles.

Regarding the embodiments of FIGS. 3-5, it is noted that the respective rubbing portions 303, 403 may be made from a porous flexible material, but could also be made from a non-porous flexible material provided at its outer surface with holes or channels capable of containing the liquid toner.

FIG. 6 illustrates a further developed embodiment comprising a first roller in the form of a developer roller 601 and a second roller in the form of an imaging roller 620. The developer roller 601 is in rotational contact with the imaging roller 620 to transfer a portion of the quantity of liquid toner onto the imaging roller 620 in accordance with a charge pattern sustained on the surface of the imaging roller 620. An upstream corona charger 621 is arranged opposite to a surface of the developer roller 601, upstream of the area of its rotational contact with the imaging roller 620, in order to charge the imaging particles contained in the liquid toner before reaching the imaging roller 620. A downstream discharge corona 622 is arranged opposite to the developer roller 601, downstream of the area of contact between the developer roller 601 and the imaging roller 620. The discharge corona 622 may be controlled based on the measurement by an electrostatic voltage sensor 623, as disclosed in unpublished patent application No. NL 2010573 in the name of the Applicant filed on 5 Apr. 2013. In order to further loosen the toner liquid after being discharged by the discharge corona 622, a loosening roller 602 is provided downstream of the discharge corona 622. In that way, the liquid toner is further subjected to a mechanical rubbing and agitating to further improve the cleaning and caking performance.

Instead of providing a corona discharger 622, the loosening roller could also function as a discharge roller. To achieve this, the loosening roller may be biased with suitable DC and/or AC voltage, as disclosed in unpublished European patent application No. EP 13 162 556.8 in the name of the Applicant filed on 5 Apr. 2013, the content of which is included herein by reference. The skilled person understands that this feature may be added to any of the above disclosed embodiments. In embodiments where the loosening roller also functions as a discharging roller, it is advantageous to use an electrically conductive material, in particular a conductive foam, for the rubbing portion.

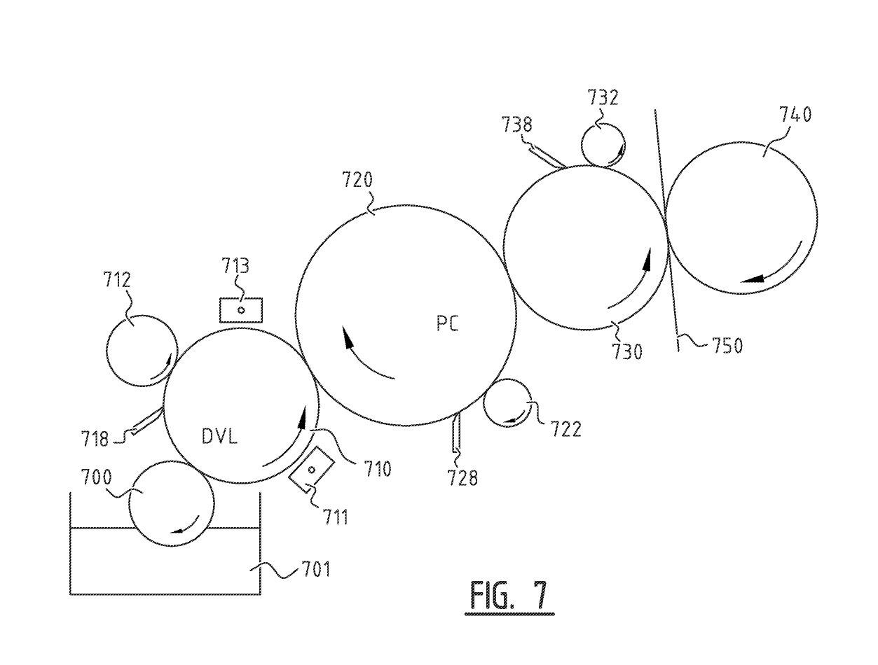

FIG. 7 illustrates a further developed embodiment of a digital printing apparatus of the disclosure, comprising a reservoir 701, a feed member 700, a developer member 710, an imaging member 720, a transfer member 730 and a support member 740. A substrate 750 is transported between transfer member 730 and support member 740. Without loss of generality, the aforementioned members are illustrated and described as rollers, but the skilled person understands that they can be implemented differently, e.g. as belts. The developer roller 710, the imaging roller 720, and the transfer roller 730 all transfer a part of the liquid toner adhering to their surface to their successor. The fraction of the liquid toner that remains present on the respective roller surface is removed after the transfer by appropriate removal means. Those means may comprise a loosening roller according to embodiments of the present disclosure.

In the illustrated example, a corona charger 711 is provided opposite to the developer roller 710, downstream of an area of rotational contact between the feed roller 700 and the developer roller 710, and upstream of an area of rotational contact between the imaging roller 720 and the developer roller 710. A discharging corona 713 is provided downstream of the area of the rotational contact between the developer roller 710 and the imaging roller 720. Further, downstream of the discharge corona 713 there is provided a loosening roller 712 followed by a scraper 718. The loosening roller 712 and the scraper 718 may be embodied as disclosed in connection with FIG. 1, FIG. 2, FIG. 3 or FIG. 5. Also, instead of using a loosening roller 712, a loosening blade could be used. In a similar way, the imaging roller 720 and the transfer roller 730 may be provided with a loosening roller 722, 732 and a scraper 728, 738, respectively. Also for those rollers, the loosening roller could be preceded by a discharge corona. Further, the loosening rollers 722, 732 could be replaced with loosening blades.

According to non-illustrated further embodiments, additional liquid such as fresh ink may be injected on the rubbing portion of the loosening member in order to further facilitate the loosening.

To test the efficiency of a rubbing roller according to embodiments of the disclosure, a test set-up was prepared including a first roller, a scraper, and a sponge roller upstream of the scraper, as in FIG. 6, but without the erase corona. In the test configuration the rubbing roller had an opposite rotation direction with respect to the developer roller. Initial tests were done with following presets:
rotational speed of the first roller 1 m/s; rotational speed of the sponge roller −1 m/s, −0.5 m/s and −0.25 m/s;
a reference test was performed for a non-charged liquid toner;
a toner liquid with a toner charge of 35 V was transferred on the first roller; this test was performed with and without the sponge roller.

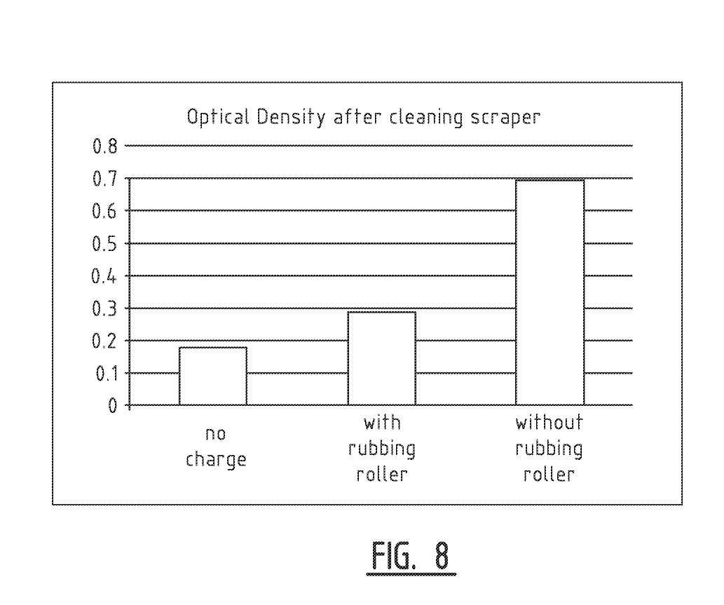

To evaluate the performance, the optical density of the toner liquid was measured downstream of the scraper. The optical density is a measure for the cleaning performance, and hence for the decompacting performance. These tests show very good results in both cleaning and caking performance. The measured optical density is illustrated in FIG. 8, and summarized below:
optical density after scraper without sponge roller: OD=0.7;
optical density after scraper with sponge roller: OD≈0.3 (the OD value was roughly the same for −1 m/s, −0.50 m/s and −0.25 m/s);
optical density after scraper with no charge (reference): OD=0.18.

In conclusion, using embodiments of a digital printing apparatus of the disclosure, caking is significantly reduced and the cleaning performance is increased. Even without the use of an erase corona or electrode, the caking and cleaning performance can be significantly improved.

While the disclosure has been described hereinabove with reference to embodiments using positively charged toner particles and electric tensions or fields arranged to act on these positively charged toner particles, in particular to electrophoretically move them, a skilled person will immediately appreciate that the disclosure equally applies to embodiments using negatively charged toner particles. In the latter case, the polarity of the electric fields acting on the toner particles needs to be reversed, leading to a physically equivalent arrangement with the same technical effects. All voltage ranges mentioned in the present description with respect to embodiments operating with positively charged toner particles are hereby stated to also apply to corresponding embodiments operating with negatively charged toner particles, provided that the sign of the voltage values is changed.

Whilst the principles of the disclosure have been set out above in connection with specific embodiments, it is to be understood that this description is merely made by way of example and not as a limitation of the scope of protection which is determined by the appended claims.

What is claimed is:

1. A digital printing method using liquid toner, the method comprising:
transporting liquid toner comprising charged, caked and compacted imaging particles on a first member in a transport direction of said first member;
wherein the method further comprises:
loosening compacted and caked imaging particles by rubbing using a rubbing portion that is being pressed against the first member and that at least partially contains or absorbs the liquid toner while being pressed against the first member; and
scraping off loosened and decaked imaging particles using a scraper downstream of an area of contact between the first member and the rubbing portion.

2. Method of claim 1, further comprising:
receiving a quantity of liquid toner comprising chargeable imaging particles on the first member, charging and compacting said chargeable imaging particles on said first member by applying an electric field in order to obtain said liquid toner comprising charged, caked and compacted imaging particles on the first member.

3. Method of claim 1, wherein the first member is a developer member, and the method further comprises:
producing a latent image as a pattern of electric charge on an imaging member; and
developing said latent image by transferring a portion of the liquid toner comprising charged, caked and compacted imaging particles onto said imaging member, in accordance with said pattern, said developing leaving a remaining fraction of said liquid toner on the developer member;
wherein the loosening is performed on said remaining fraction.

4. Method of claim 1, wherein the rubbing portion is made of an elastic foam material capable of absorbing liquid toner.

5. Method of claim 1, wherein the rubbing portion is an outer layer of a counter rotating roller in rotatable contact with the first member, said counter rotating roller rotating in a direction opposite to the transport direction of the first member.

6. Method of claim 1, wherein the rubbing portion is biased for discharging the charged, compacted and caked imaging particles.

7. A digital printing method using liquid toner, the method comprising:
transporting liquid toner comprising charged, caked and compacted imaging particles on a first member in a transport direction of said first member;
wherein the method further comprises:
loosening compacted and caked imaging particles by rubbing using an outer layer of a counter rotating roller in rotatable contact with the first member, said outer layer being pressed against the first member and at least partially absorbing the liquid toner while being pressed against the first member;
said counter rotating roller rotating in a direction opposite to the transport direction of the first member; and
scraping off loosened and decaked imaging particles using a scraper downstream of an area of contact between the first member and the rubbing portion.

8. Method of claim 7, further comprising:
receiving a quantity of liquid toner comprising chargeable imaging particles on the first member, charging and compacting said chargeable imaging particles on said first member by applying an electric field in order to obtain said liquid toner comprising charged, caked and compacted imaging particles on the first member.

9. Method of claim 7, wherein the first member is a developer member, and the method further comprises:
producing a latent image as a pattern of electric charge on an imaging member; and
developing said latent image by transferring a portion of the liquid toner comprising charged, caked and compacted imaging particles onto said imaging member, in accordance with said pattern, said developing leaving a remaining fraction of said liquid toner on the developer member;
wherein the loosening is performed on said remaining fraction.

10. Method of claim 7, wherein the rubbing portion is made of an elastic foam material capable of absorbing liquid toner.

11. A digital printing apparatus using liquid toner comprising chargeable imaging particles, the apparatus comprising:
a first member arranged to receive and transport a quantity of liquid toner in a transport direction;
wherein the digital printing apparatus further comprises:
a loosening member arranged to loosen liquid toner present on said first member, wherein the loosening member has a rubbing portion arranged to rub the liquid toner to be loosened, said rubbing portion being arranged and configured for being compressed by the first member and for being capable of at least partially containing or absorbing the liquid toner during compression by the first member; and
a scraper arranged opposite to the first member, downstream of an area of contact between the first member and the loosening member and configured to scrape off loosened liquid toner.

12. Digital printing apparatus of claim 11, wherein the first member is any one of the following:
a development member arranged to receive a quantity of liquid toner, and to develop a latent image by transferring a portion of the quantity of liquid toner onto an imaging member;
an imaging member adapted to sustain a pattern of electric charge forming a latent image on its surface;
a transfer member configured for transferring liquid toner from an imaging roller to a substrate.

13. Digital printing apparatus of claim 11, wherein a charging member is arranged opposite to the first member, upstream of an area of contact between the first member and the loosening member.

14. Digital printing apparatus of claim 11, wherein the rubbing portion is contact with the first member over a length of at least 5 mm seen in the transport direction of the first member, wherein the scraper is operative at a distance of at least 5 mm, seen in the transport direction, from a point of first contact between the rubbing portion and the first member.

15. Digital printing apparatus of claim 11, wherein the rubbing portion is made of an elastic foam material capable of absorbing liquid toner.

16. Digital printing apparatus of claim 11, wherein the rubbing portion is made of an electrically conducting material, and wherein the loosening member is configured for biasing the rubbing portion with a voltage or current adapted for partially or fully discharging the liquid toner.

17. Digital printing apparatus of claim 11, further comprising an actuator for moving said loosening member, such that liquid toner is rubbed by the rubbing portion whilst being absorbed or contained in or on said rubbing portion.

18. Digital printing apparatus of claim 11, wherein the loosening member is a rotatable member being in operation in rotating contact with the first member;
wherein the actuator is configured for rotating the loosening member; and
wherein the rubbing portion is provided as an outer layer of the rotatable member.

19. Digital printing apparatus of claim 11, wherein the loosening member is configured to rotate in an opposite direction compared to the first member, seen at an area of contact between the first and the loosening member, such that a liquid pick-up zone is created upstream of said area of contact and a squeeze-out zone is created downstream of said area of contact.

20. Digital printing apparatus of claim 11, further comprising a second member being in contact with the first member, wherein the first member is configured and arranged to transfer a portion of the quantity of liquid toner onto the second member, leaving a remaining fraction of said quantity of liquid toner on the first member;
wherein the loosening member and the scraper are arranged to act on said remaining fraction;
wherein preferably the second member is an imaging member adapted to sustain a pattern of electric charge forming a latent image on its surface;
wherein preferably the first member is a development member arranged to receive a quantity of liquid toner, and to develop said latent image by transferring a portion of said quantity of liquid toner onto said imaging member in accordance with said pattern;
wherein preferably a charging member is arranged opposite to the first member, upstream of an area of contact between the first member and the second member.
